(19) United States
(12) Patent Application Publication
(10) Pub. No.: US 2015/0006579 A1
(43) Pub. Date: Jan. 1, 2015

(54) CUSTOM GROUPING OF MULTIDIMENSIONAL DATA

(71) Applicant: Boris Kovacevic, Vancouver (CA)

(72) Inventor: Boris Kovacevic, Vancouver (CA)

(21) Appl. No.: 13/927,569

(22) Filed: Jun. 26, 2013

(51) Int. Cl. G06F 21/62

(52) U.S. Cl. CPC G06F 21/6218
USPC 707/781

(57) ABSTRACT

A system may include reception, from a first runtime client, of criteria for selecting a group of data members from a data source, wherein the criteria does not identify any data members of the group of data members, saving of the criteria in association with the data source, reception of a first request to access the data source, reception of a second request to determine one or more measures associated with the group of data members, determination, in response to the second request, of a plurality of data members of the group of data members based on the criteria, and determination of the one or more measures associated with the determined plurality of members.

### BACKGROUND

Enterprise software systems receive, generate and store data related to many aspects of a business enterprise. These systems may provide reporting, planning, and/or analysis of the data based on logical entities known as dimensions and measures.

Dimensions represent sets of values (i.e., members) along which an analysis may be performed or a report may be generated (e.g., Country, Year, Product), and measures are indicators, most often numeric, whose values can be determined for a given combination of dimension members. For example, a value of the Sales measure may be determined for bicycles (i.e., a member of the Product dimension) in January (i.e., a member of the Month dimension).

### BRIEF DESCRIPTION OF THE DRAWINGS

FIG. 1 is a block diagram of a system according to some embodiments.

FIG. 2 is a flow diagram of a process according to some embodiments.

FIG. 3 is a view of a user interface according to some embodiments.

FIG. 4 is a view of a user interface according to some embodiments.

FIG. 5 is a view of a user interface according to some embodiments.

FIG. 6 is a view of a user interface according to some embodiments.

FIG. 7 is a view of a user interface according to some embodiments.

FIG. 8 is a view of a user interface according to some embodiments.

FIG. 9 is a view of a user interface according to some embodiments.

FIG. 10 is a block diagram of a system according to some embodiments.

FIG. 11 is a block diagram of a computing device according to some embodiments.

### DETAILED DESCRIPTION

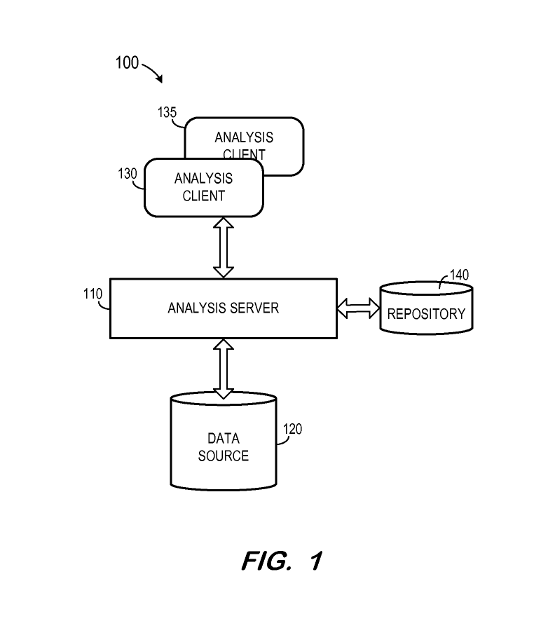

FIG. 1 is a block diagram of system 100 according to some embodiments. FIG. 1 represents a logical architecture for describing processes according to some embodiments, and actual implementations may include more or different components arranged in other manners.

System 100 includes analysis server 110 to provide data of data source 120 to analysis clients 130 and 135. For example, analysis server 110 may receive a request for a report from analysis client 130 or 135, query data source 120 for data required by the report, receive the data from data source 120, perform any necessarily calculations on the data, format the report including its data, and return the report to the requesting analysis client 130 or 135.

Data source 120 may comprise any one or more systems to store business data. The data stored in data source 120 may be received from disparate hardware and software systems, some of which are not interoperational with one another. The systems may comprise a back-end data environment employed in a business or industrial context. The data may be pushed to data source 120 and/or provided in response to queries received therefrom.

The data may comprise a relational database, a multi-dimensional database, an eXtendable Markup Language (XML) document, and/or any other structured data storage system. The physical tables of data source 120 may be distributed among several relational databases, multi-dimensional databases, and/or other data sources. For example, data source 120 may comprise one or more OnLine Analytical Processing (OLAP) databases (i.e., cubes). To provide economies of scale, data source 120 may include data of more than one customer. In this scenario, analysis server 110 includes mechanisms to ensure that a client accesses only the data that the client is authorized to access. Moreover, the data of data source 120 may be indexed and/or selectively replicated in an index.

Data source 120 may implement an “in-memory” database, in which volatile (e.g., non-disk-based) storage (e.g., Random Access Memory) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data comprises one or more of conventional tabular data, row-based data stored in row format, column-based data stored in columnar format, and object-based data.

Analysis clients 130 and 135 may comprise one or more devices executing program code of a software application for presenting user interfaces to allow interaction with analysis server 110. Analysis clients 130 and 135 may comprise a desktop computer, a laptop computer, a personal digital assistant, a tablet PC, and a smartphone, but is not limited thereto. Analysis clients 130 and 135 may execute program code of a spreadsheet application, a spreadsheet application with a plug-in allowing communication (e.g. via Web Services) with analysis server 110, a rich client application (e.g., a Business

Intelligence tool), an applet in a Web browser, or any other application to perform the processes attributed thereto herein.

Repository 140 stores metadata and data for use by analysis server 110. The metadata may specify a schema of data source 120, which may be used by analysis server 110 to query data source 120. As will be described below, the metadata may define users, workspaces, data source connections, and custom groups of dimension values.

Although system 100 has been described as a distributed system, system 100 may be implemented in some embodiments by a single computing device. For example, both analysis client 130 and analysis server 110 may be embodied by an application executed by a processor of a desktop computer, and data source 120 may be embodied by a fixed disk drive within the desktop computer.

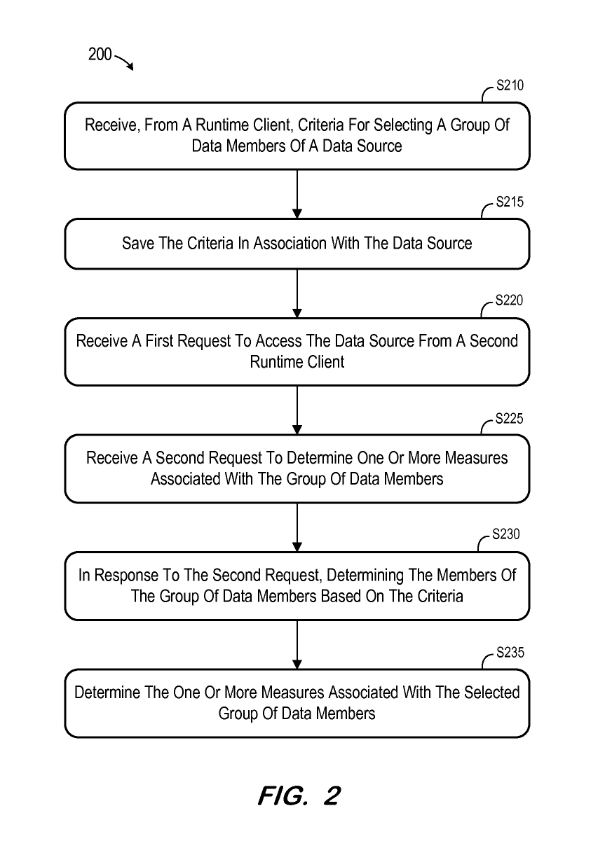

FIG. 2 comprises flow diagram of process 200 according to some embodiments. In some embodiments, various hardware elements of system 100 execute program code to perform process 200. In some embodiments, hard-wired circuitry may be used in place of, or in combination with, program code for implementation of processes according to some embodiments. Embodiments are therefore not limited to any specific combination of hardware and software.

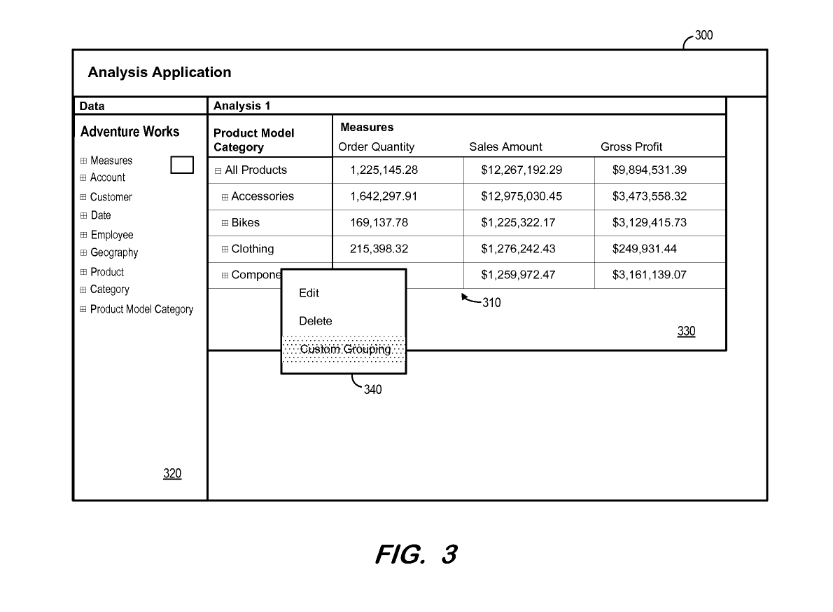

Prior to S210, a first user operates analysis client 130 to display a user interface for interacting with analysis server 110. To assist in the present description of an example of process 200, FIG. 3 shows a view of user interface 300 according to some embodiments. User interface 300 may be presented on a display of analysis client 130 in response to execution of a Business Intelligence tool by a processor of analysis client 130. Alternatively, user interface 300 may be a Web page displayed by a Web browser application executed by the processor. Embodiments are not limited to these examples.

User interface 300 of FIG. 3 illustrates result set 310 based on a data source entitled “Adventure Works”. The data source may comprise an OLAP cube defining dimensions, dimension members and measures. According to the present example, it will be assumed that a user has manipulated user interface 300 to display result set 310 at S210. Any querying/reporting/analysis paradigm that is or becomes known may be used to retrieve result set 310 according to some embodiments. In some examples, the user drags and drops one or more dimensions, dimension members and measures of the data source from a list within data window 320 into workspace 330. For clarity, the details of such a list are not shown in FIG. 3.

Result set 310 is associated with the Product Model Category hierarchy and with measures Order Quantity, Sales Amount and Gross Profit, but embodiments are not limited to one hierarchy or to more than one measure. A hierarchy is a logical tree of members of a particular dimension. In this example, the Product Model Category hierarchy includes members of the Product dimension, selected and arranged by a developer or system administrator in a manner intended to provide useful functionality to a business user. Result set 310 shows sub-hierarchies of the Product Model Category hierarchy and, for each sub-hierarchy, an aggregated value for each of the measures Order Quantity, Sales Amount and Gross Profit.

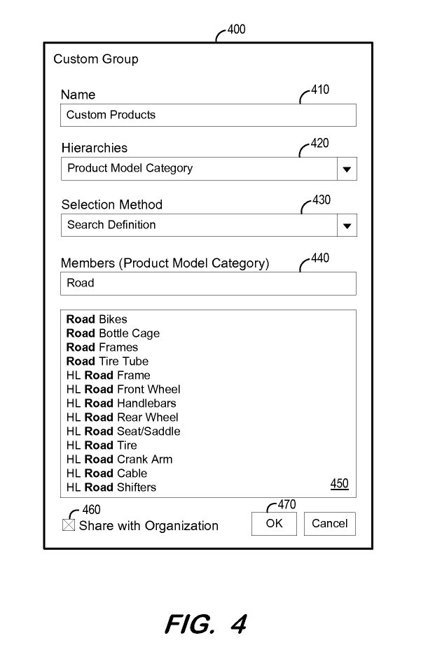

Continuing with S210, the user may “right-click” on result set 340, or perform any other suitable input gesture, to cause display of context menu 340. The “Custom Grouping” option is selected and, as a result, dialog window 400 of FIG. 4 is displayed. Window 400 allows the user to specify criteria for selecting a group of data members according to some embodiments.

In particular, the user may specify a name for the group in field 410, and may use pull-down menu 420 to indicate a hierarchy from which the members will be selected. Menu 420 is pre-populated with the hierarchy of result set 310, but embodiments are not limited thereto.

Pull-down menu 430 allows the user to specify a method by which the data members of the group will be selected at runtime. In the present example, the method is Search Definition. This method involves selecting members which satisfy search terms specified in field 440.

The term “Road” has been entered in field 440. In response, area 450 presents a list of current members of the Product Model Category dimension having names which include the word “Road”. Embodiments are not limited to selection of members from a single hierarchy or to a single search term. In this regard, field 440 may accept any known search operators, including but not limited to AND, OR and NOT.

Checkbox 460 may be selected to allow other users to the custom group. If checkbox 460 is not selected, the custom group will be accessible only to the user who created the custom group.

The criteria for selecting the group are received at S210 upon selection of OK button 470. The criteria may include one or more dimension hierarchies specified in menu 420, the selection method specified in menu 430, and one or more search terms specified in field 440. It should be noted that, in some embodiments, the selection criteria do not include the members listed in area 450. Rather, and as will be described below, the selection criteria are used at runtime to determine those members which meet the selection criteria at the time the custom group is accessed. The group members determined at that time may differ from those listed in area 450 if members of the specified hierarchies have been added or deleted, or have been renamed.

The criteria are saved in association with the data source at S215. In some embodiments, the selection criteria are received by analysis server 110 at S210. Accordingly, at S215, analysis server 110 generates metadata specifying the selection criteria and associating the selection criteria with the data source (e.g., an OLAP cube) from which the hierarchies were obtained. In the above example, because checkbox 460 was checked, the metadata does not exclusively associate the selection criteria with the user. The metadata is saved to repository 140 at S215.

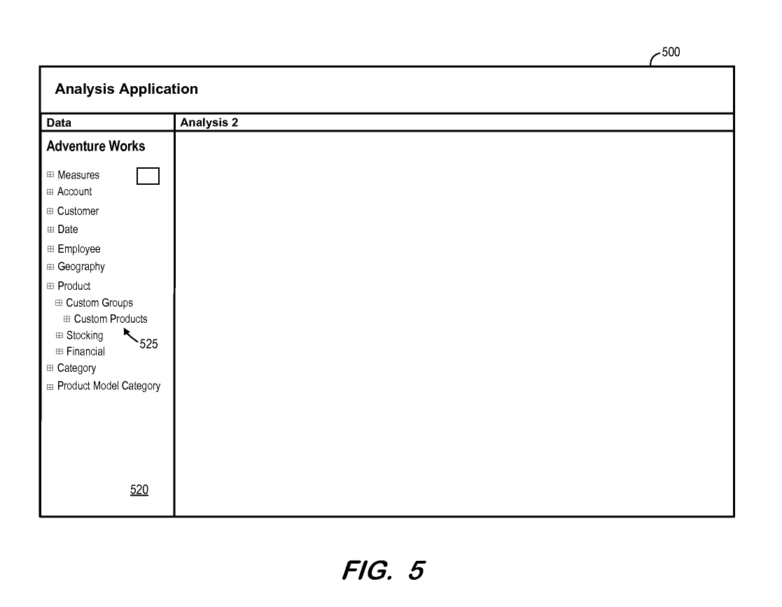

Next, at S220, a request to access the data source is received from a second runtime client. The second runtime client may comprise the first user, the first client device, a second user, and/or a second client device. Continuing the present example, a second user operating client device 135 may request to access the Adventure Works OLAP cube at S220. FIG. 5 is a view of interface 500 which is displayed in response to the request.

As shown, data window 520 includes Custom Products group 525 described above. Custom Products group 525 is listed under the Product dimension because the members of Custom Products group 525 are members of the Product dimension. In some embodiments, Custom Products group 525 may be presented in data window 520 as a standalone hierarchy (i.e., similar to the Product Model Category hierarchy).

At S225, a request is received to determine one or more measures associated with the custom group. For example, the user of interface 500 may drag and drop Custom Products group 525 and the one or more measures, along with any other dimension members, from data window 520 into workspace 530. Such an action may comprise a request to determine the one or more measures associated with the custom group.

In response to the request, the members of the custom group are determined at S230. The determination is based on the criteria received at S210. Accordingly, in some embodiments, analysis server 110 retrieves the criteria from metadata 140 and evaluates the criteria at S230 to determine the members of the custom group. With respect to the above example, analysis server 110 identifies members of the Product Model Category dimension hierarchy having names including the term “Road”. As mentioned above, the members determined at S230 may be different from the members listed in area 450 of dialog 400.

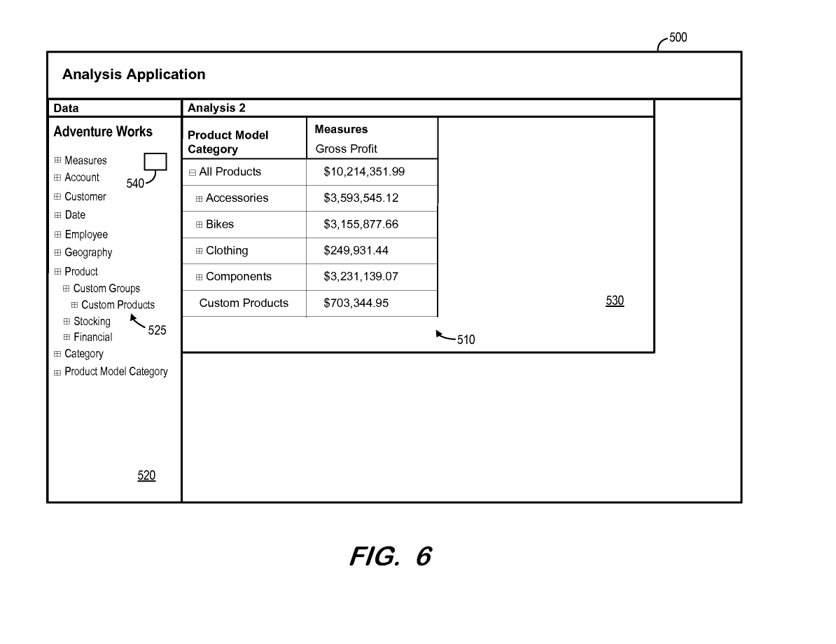

The one or more measures are determined (i.e., evaluated) for the determined members at S235. Determination of the measures may consist of identifying (or calculating) a value of each measure for each determined member. Depending upon the request received at S225, the determined measures may be aggregated (e.g., SUM) for the whole set of members or determined for one or more individual members. FIG. 6 is a view of interface 500 after S235 according to some embodiments. As shown, the user has dragged the Product Model Category hierarchy and the Gross Profit measure into area 530, thereby creating result set 510. Result set 510 includes a row associated with the Custom Products group and including a value of the Gross Profit measure. The value of the Gross Profit measure is an aggregated value of the Gross Profit measure associated with each member of the Custom Products group that was selected at S230.

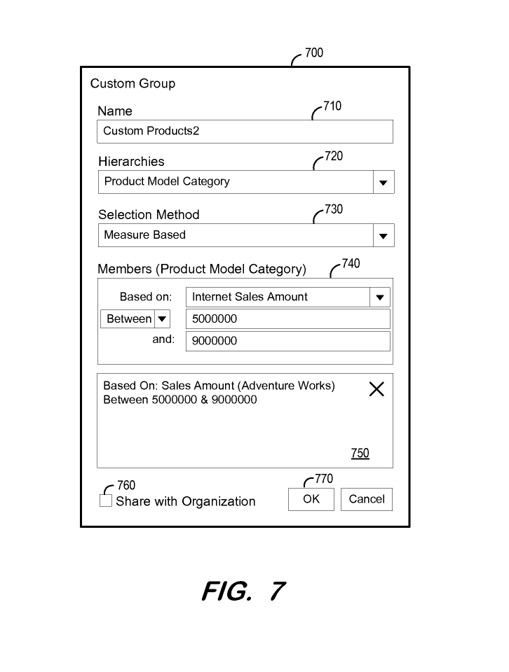

Some embodiments provide types of member selection criteria in addition to or different from the selection criteria described with respect to FIG. 4. An example will now be described in which the user of interface 500 selects “Add Custom Group” icon 540 shown in FIG. 6. In response, dialog 700 of FIG. 7 is displayed.

Dialog 700 is similar to dialog 400 of FIG. 4. Field 710 receives the name of the custom group, and pull-down menu 720 allows the user to specify one or more dimension hierarchies from which to select members. Pull-down menu 730 determines the selection method, which is “Measure Based” in the illustrated case. Generally, this selection method selects dimension members based on one or more associated measure values.

The user defines measure-based selection criteria in area 740. Specifically, the user specifies a measure (e.g., Internet Sales Amount) and a measure criteria. In the illustrated embodiment, the criteria is a range between 5,000,000 and 9,000,000. Accordingly, the measure-based selection criteria of FIG. 7 specifies selection of those members of the Product Model Category hierarchy which are associated with an Internet Sales Amount of between 5,000,000 and 9,000,000. As stated above, the selected members may differ depending upon when the selection criteria are evaluated.

Any other measure-based selection criteria may be specified in some embodiments. For example, the criteria may require the measure to be equal to a particular value, less than a particular value, greater than a particular value, or to have any other relation to one or more particular values (or other measures).

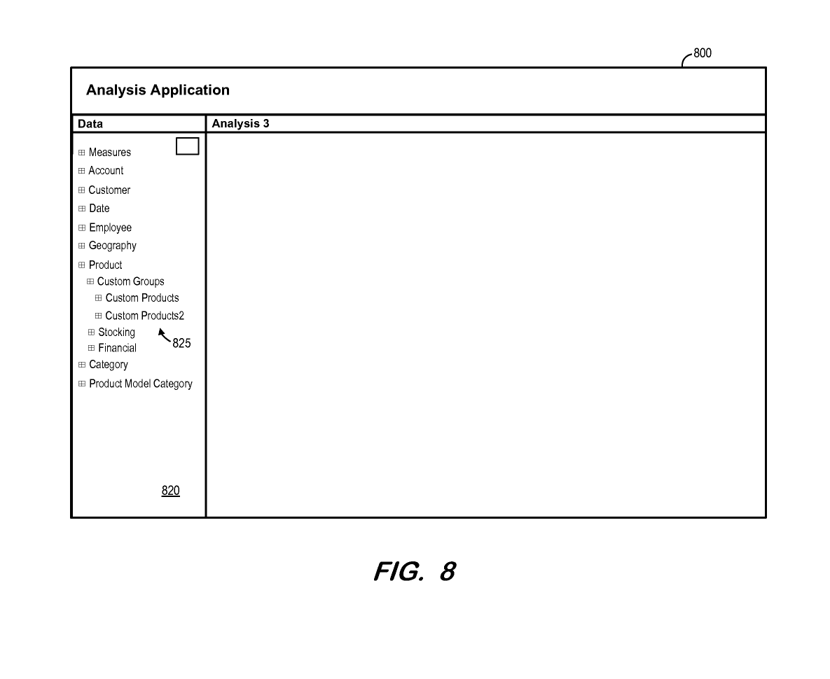

The illustrated example allows the user to define more than one measure-based selection criteria. Each defined measure-based selection criteria is shown in area 750, and may be deleted by selecting the “X” icon therein. Also in the illustrated example, the user has not selected checkbox 760. Accordingly, upon selection of OK button 770, metadata defining the selection criteria will be saved as described above, but the metadata will specify that the custom group is accessible only by the user of interface 700. In this regard, FIG. 8 shows interface 800 displayed to such a user, in which Custom Products2 group 825 is now also present in window 820.

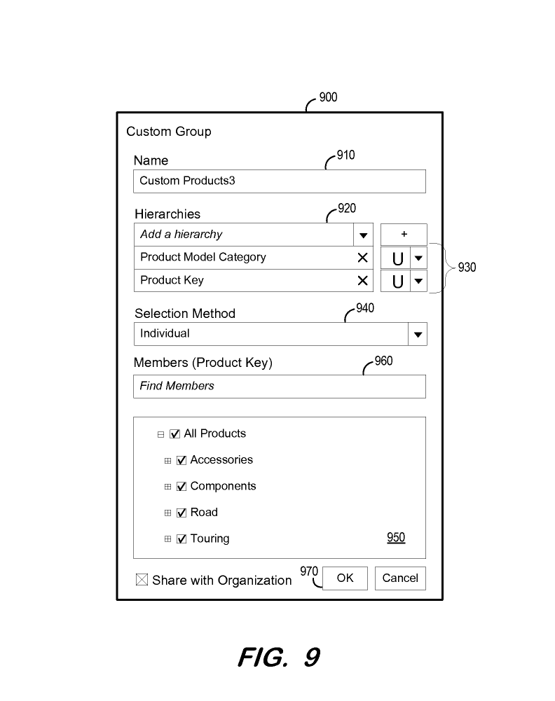

FIG. 9 illustrates the definition of another type of member selection method according to some embodiments. Dialog 900 includes field 910 to receive the name of the custom group, and pull-down menu 920 allows the user to specify one or more dimension hierarchies. Pull-down menus 930 may be used to specify a logical combination of the specified dimension hierarchies. For example, the illustrated Union operator indicates that the members of the custom group will be selected from the Union of the members of the specified hierarchies. In contrast, members of the custom group will be selected from the Intersection of the members of the specified hierarchies in a case that the Intersection operator is specified in pull-down menus 930.

An Individual selection method is indicated in pull-down menu 940, indicating that the members of the custom group will be individually selected by the user within area 950. In this regard, area 950 lists the logically-combined dimension hierarchies as specified by menu 920 and menus 930. The listed members may be filtered via search terms entered into input field 960.

As before, metadata defining the selected members is saved in association with the data source in response to user selection of OK button 970.

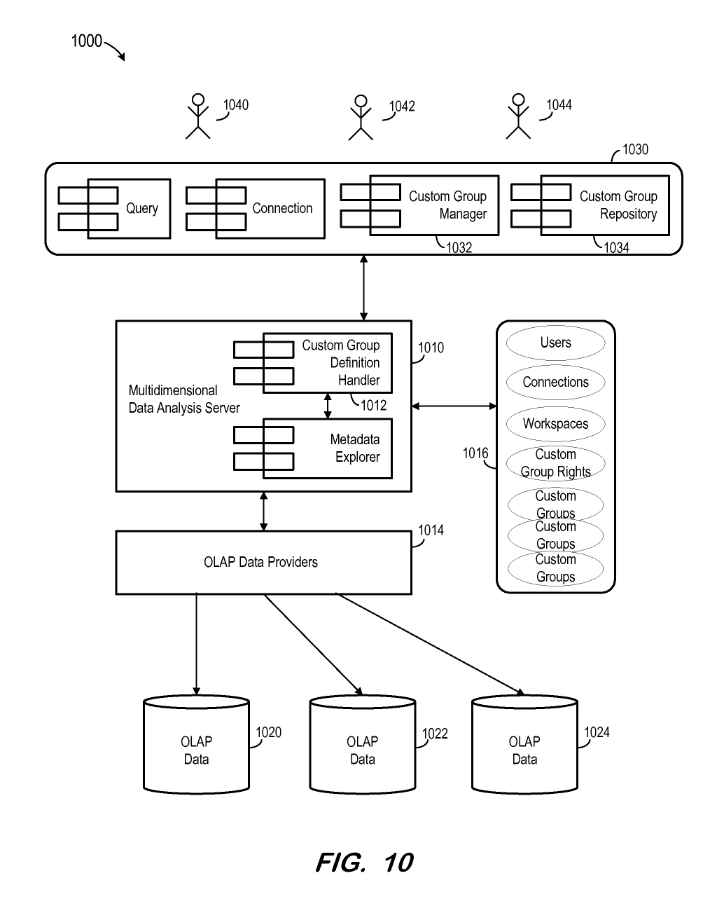

FIG. 10 is a block diagram of system 1000 according to some embodiments. One or more elements of system 1000 may implement one or more elements of system 100 of FIG. 1.

In operation, one of business analysts 1040, 1042 or 1044 uses analysis client 1030 to access an OLAP data source 1020, 1022 or 1024 through analysis server 1010. The analyst interfaces with analysis Web client 1030 as described above to generate criteria for selecting a group of data members of the data source. Custom Group Definition Handler 1012 saves the criteria in repository 1016 (e.g., as Custom Group metadata), and associates the criteria with a corresponding workspace, OLAP connection, and user object of the creating analyst (if the Custom Group is not designated for public sharing).

Later, if one of business analysts 1040, 1042 or 1044 accesses the same OLAP connection, Custom Group Manager 1032 checks Custom Group Repository 1034 to retrieve the Custom Group definition. Custom Group Definition Handler 1012 then invokes one of OLAP data provider 1014 to express the Custom Group as an appropriate MultiDimensional eXpression (MDX) statement and retrieve the corresponding OLAP data. This data is returned through analysis server 1010 and analysis Web client 1030 to the appropriate business analyst 1040, 1042 or 1044.

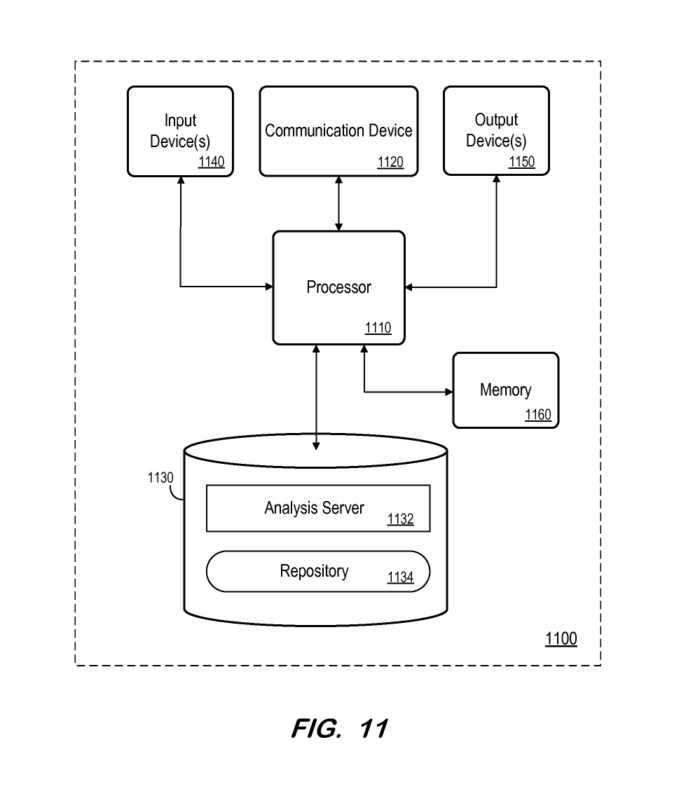

FIG. 11 is a block diagram of apparatus 1100 according to some embodiments. Apparatus 1100 may comprise a general-purpose computing apparatus and may execute program code to perform any of the functions described herein. Apparatus 1100 may comprise an implementation of one or more elements of system 100 or system 1000, such as analysis server 110 (1010) and repository 140 (1016). Apparatus 1100 may include other unshown elements according to some embodiments.

Apparatus 1100 includes processor 1110 operatively coupled to communication device 1120, data storage device 1130, one or more input devices 1140, one or more output devices 1150 and memory 1160. Communication device 1120 may facilitate communication with external devices, such as an external design tool. Input device(s) 1140 may comprise, for example, a keyboard, a keypad, a mouse or other pointing device, a microphone, knob or a switch, an infra-red (IR) port, a docking station, and/or a touch screen. Input device(s) 1140 may be used, for example, to enter information into apparatus 1100. Output device(s) 1150 may comprise, for example, a display (e.g., a display screen) a speaker, and/or a printer.

Data storage device 1130 may comprise any appropriate persistent storage device, including combinations of magnetic storage devices (e.g., magnetic tape, hard disk drives and flash memory), optical storage devices, Read Only Memory (ROM) devices, etc., while memory 1160 may comprise Random Access Memory (RAM).

Analysis server 1132 of data storage device 1130 may comprise program code executable by processor 1110 to provide any of the functions described herein, including but not limited to process 200. Embodiments are not limited to execution of these functions by a single apparatus. Repository 1134 may store the metadata described herein with respect to repository 140 (1016). Memory 1160 may also or alternatively store data of repository 140 (1016) and/or data source 110, with data storage device 1130 providing a persistent backup. Data storage device 1130 may also store data and other program code for providing additional functionality and/or which are necessary for operation thereof, such as device drivers, operating system files, etc.

Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 100 or system 1000 may include a processor to execute program code such that the computing device operates as described herein.

All systems and processes discussed herein may be embodied in program code stored on one or more computer-readable non-transitory media. Such media non-transitory media may include, for example, a fixed disk, a floppy disk, a CD-ROM, a DVD-ROM, a Flash drive, magnetic tape, and solid state RAM or ROM storage units. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, the method comprising:
receiving, from a first runtime client, criteria for selecting a group of data members from a data source, wherein the criteria does not identify any data members of the group of data members;
saving the criteria in association with the data source;
receiving a first request to access the data source;
receiving a second request to determine one or more measures associated with the group of data members;
in response to the second request, determining a plurality of data members of the group of data members based on the criteria; and
determining the one or more measures associated with the determined plurality of members.

2. A method according to claim 1, wherein the first request is received from a second runtime client, the method further comprising:
determining whether the second runtime client is permitted to access the group of data members.

3. A method according to claim 1, wherein the criteria comprises search terms, and
wherein determining the plurality of members of the group of data members comprises determining a plurality of members which meet the search terms.

4. A method according to claim 1, wherein determining the plurality of members of the group of data members comprises determining a plurality of members having names which include the search terms.

5. A method according to claim 1, wherein the criteria comprises a measure criteria based on one or more measure values.

6. A method according to claim 5, wherein determining the plurality of data members of the group of data members comprises determining a plurality of data members associated with measure values which meet the measure criteria.

7. A non-transitory medium storing processor-executable program code, the program code executable by a processor of a computing device to:
receive, from a first runtime client, criteria for selecting a group of data members from a data source, wherein the criteria does not identify any data members of the group of data members;
save the criteria in association with the data source;
receive a first request to access the data source;
receive a second request to determine one or more measures associated with the group of data members;
in response to the second request, determine a plurality of data members of the group of data members based on the criteria; and
determine the one or more measures associated with the determined plurality of members.

8. A non-transitory medium according to claim 7, wherein the first request is received from a second runtime client, the program code further executable by a processor of a computing device to:
determine whether the second runtime client is permitted to access the group of data members.

9. A non-transitory medium according to claim 7, wherein the criteria comprises search terms, and
wherein the determination of the plurality of members of the group of data members comprises determination of a plurality of members which meet the search terms.

10. A non-transitory medium according to claim 7, wherein determination of the plurality of members of the group of data members comprises determination of a plurality of members having names which include the search terms.

11. A non-transitory medium according to claim 7, wherein the criteria comprises a measure criteria based on one or more measure values.

12. A non-transitory medium according to claim 11, wherein determination of the plurality of data members of the group of data members comprises determination of a plurality of data members associated with measure values which meet the measure criteria.

13. A system comprising:
a computing device comprising:
a memory storing processor-executable program code; and
a processor to execute the processor-executable program code in order to cause the computing device to:
receive, from a first runtime client, criteria for selecting a group of data members from a data source, wherein the criteria does not identify any data members of the group of data members;
save the criteria in association with the data source;
receive a first request to access the data source;
receive a second request to determine one or more measures associated with the group of data members;
in response to the second request, determine a plurality of data members of the group of data members based on the criteria; and
determine the one or more measures associated with the determined plurality of members.

14. A system according to claim 13, wherein the first request is received from a second runtime client, the processor to execute the processor-executable program code in order to cause the computing device to:
determine whether the second runtime client is permitted to access the group of data members.

15. A system according to claim 13, wherein the criteria comprises search terms, and
wherein determination of the plurality of members of the group of data members comprises determination of a plurality of members which meet the search terms.

16. A system according to claim 13, wherein determination of the plurality of members of the group of data members comprises determination of a plurality of members having names which include the search terms.

17. A system according to claim 13, wherein the criteria comprises a measure criteria based on one or more measure values.

18. A system according to claim 17, wherein determination of the plurality of data members of the group of data members comprises determination of a plurality of data members associated with measure values which meet the measure criteria.
